(19) United States
(12) Patent Application Publication
(10) Pub. No.: US 2006/0124238 A1
(43) Pub. Date: Jun. 15, 2006

(54) Membrane, a method and die means for manufacturing same

(76) Inventor: Anders Engelbrektsson, Herrljunga (SE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/541,766

(22) PCT Filed: Jan. 9, 2004
(86) PCT No.: PCT/SE04/00007

§ 371 Date: Jul. 11, 2005

(30) Foreign Application Priority Data
Jan. 22, 2003 (SE) 0300158-3

(51) Int. Cl. B29C 65/00

(52) U.S. Cl. 156/307.1; 156/245

(57) ABSTRACT

The invention relates to a method of manufacturing a membrane (1) from a blank (39) by a cure, which membrane comprises two rubber layers (40, 41) and a fabric-formed reinforcement layer (19), positioned between said rubber layers. In order to counteract and prevent respectively undesirable displacements of the reinforcement layer (19) membrane sections, which are movable in an application position, are manufactured according to the invention having a form, which deviates from the application form, and/or are exposed to stretching during the cure in order to within the membrane section bring about a displacement of said reinforcement layer (19) across a portion of at least one of the rubber layers (40, 41) and consequently a position, which deviates from the blank building up during the cure. The invention also relates to a membrane, manufactured according to this method as well as a mold tool designed to carry out the method and the manufacture of the membrane respectively.

The present invention relates to a method of manufacturing a membrane according to the preamble of claim 1. Also, the invention relates to a membrane according to the preamble of the first means claim as well as a mold tool, designed to carry out said method and to manufacture said membrane respectively.

According to already known technology, when base materials for reinforced membranes are manufactured, one or several reinforcement layers, made of e.g. fabrics, are placed between two or several layers of a rubber elastic material, particularly rubber, and the layers are joined, e.g. through calendering. Alternatively the various layers can be placed on top of each other in a mold tool for membrane manufacturing. In the two cases these layers are permanently joined to each other by a cure process.

During the cure the rubber turns semi-liquid and penetrates into the reinforcement material layer and the various rubber layers, if several are used, are joined to each other through e.g. quite thin fabrics. The reinforcement layer will then at least mainly retain its position. However, when membranes are cured in this way, the final shaping of the membranes takes place at the same time. During more accentuated shaping of this type, with e.g, sharp bends with small radius, varying stretching and press forces are exerted on the reinforcement as well as the semi-liquid rubber layers. Then the semi-liquid rubber in one layer may be pushed aside in a planar direction and/or across the reinforcement layer and into another rubber layer, particularly when the reinforcement layer consists of a thin fabric. The reinforcement layer then moves in an undesirable way and occupies in the finished membrane another position than the desired one. Such an undesirable displacement of the reinforcement layer may in a typical case result in, that the reinforcement will be located close to a pressurized liquid or gas, which penetrates the reinforcement layer and expands the rubber layer on the other side to a bubble. Also, quite generally reinforcement displacements in relation to the desired position results in risks of functional disturbances, e.g. due to changes in the desired movability of the membrane and its elastic deformation performance, as well as risks of quality impairment.

The object of the present invention is to prevent and as far as possible eliminate the above-mentioned drawbacks as well as in other respects develop the state of the art in this technical field and find new application possibilities. In all cases undesirable displacements of the reinforcement layer or layers will be counteracted or prevented, either a desired displacement of the reinforcement layer or layers taking place within the blank or the blanks or no such displacement taking place and/or a desired stretching or prestressing of the reinforcement layer or layers being obtained, the results depending on the membrane design and the application respectively.

This object is attained according to the invention through a method of the type described in the introduction, which method is set forth in the characterizing clause of claim 1. Said object is also attained by means of a membrane, which is designed mainly according to the characterizing clause of the first means claim, and by means of a form tool according to the first form tool claim respectively. Additional characterizing features and advantages of the present invention are set forth in the following description, reference being made to the accompanying drawings, which depict a few preferred but not limiting embodiments of the invention. The drawings show in detail in diametrical, partly schematic cross sections in:

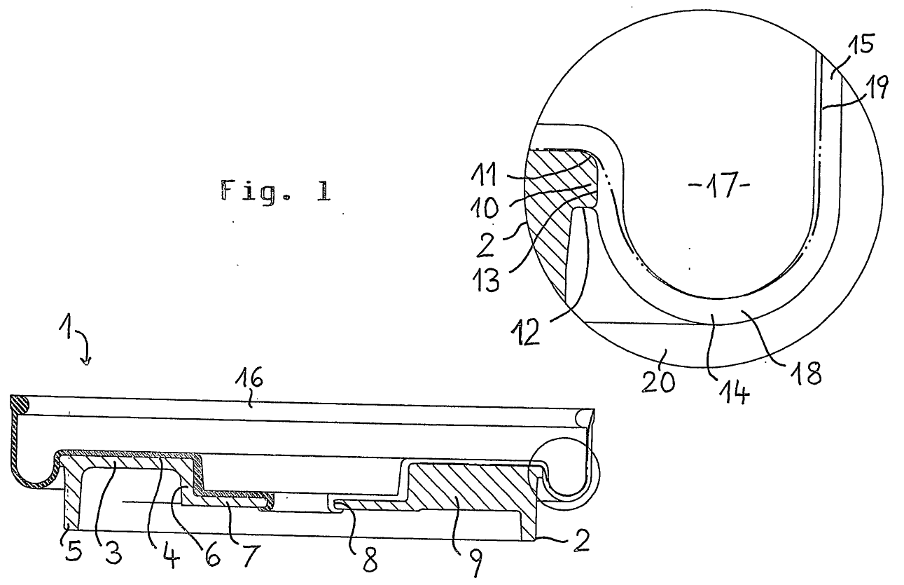

FIG. 1 the manufacturing position and the application position of a conventional membrane;

FIG. 2 the manufacturing position of a membrane according to the invention;

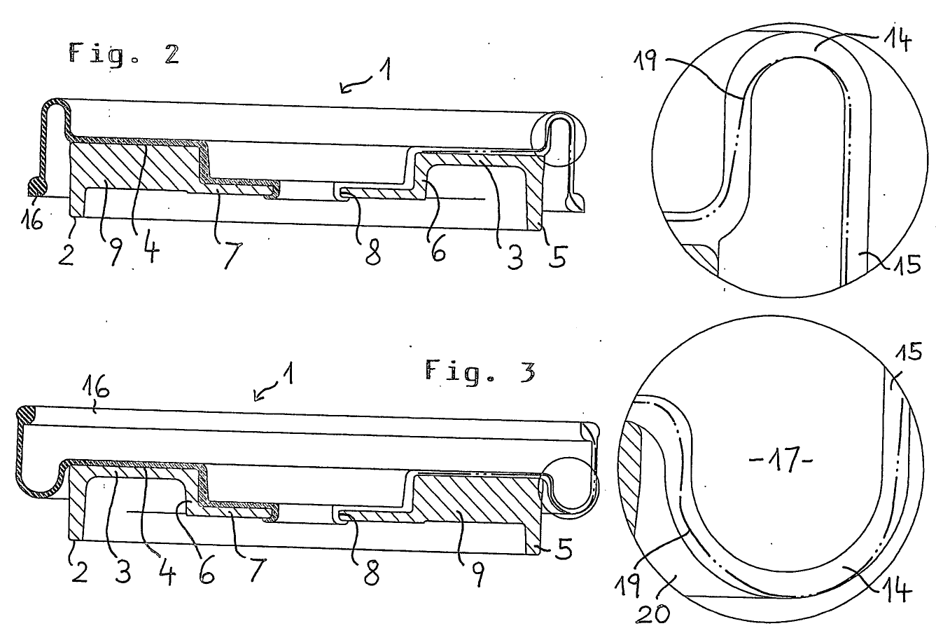

FIG. 3 the application position of the membrane according to FIG. 2;

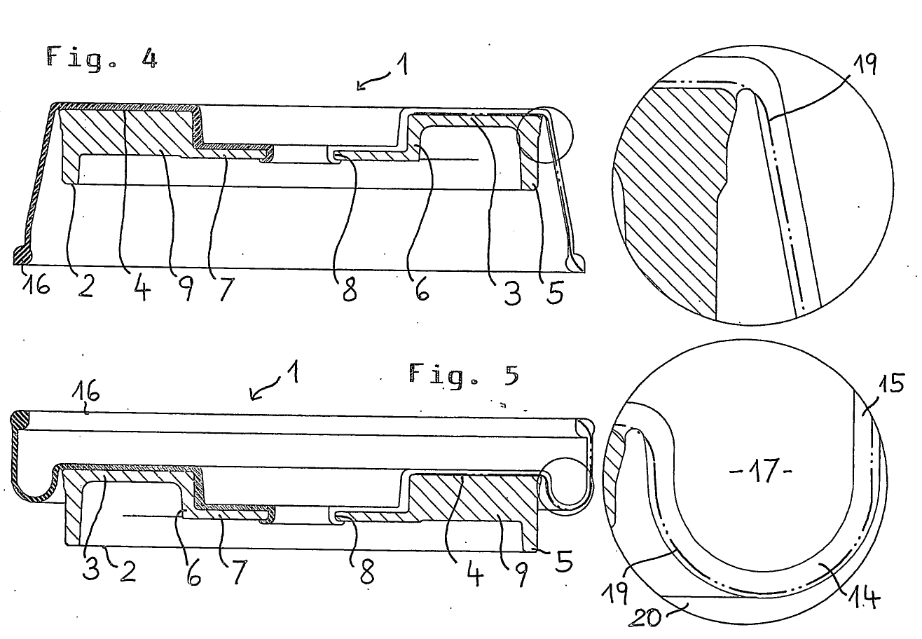

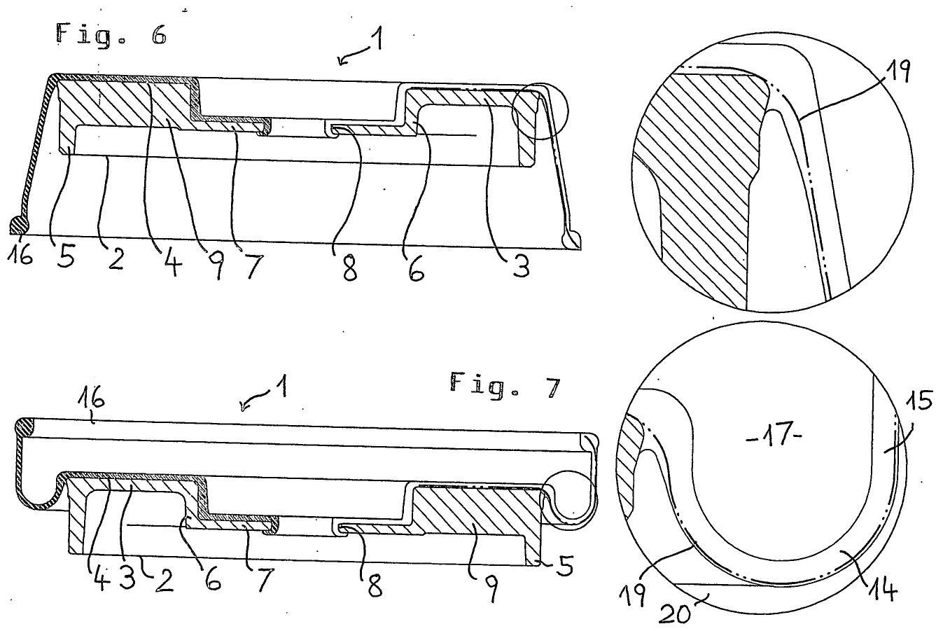

FIGS. 4 and 5 a modified manufacturing position and an application position of another membrane according to the invention;

FIGS. 6 and 7 ditto for a third membrane according to the invention;

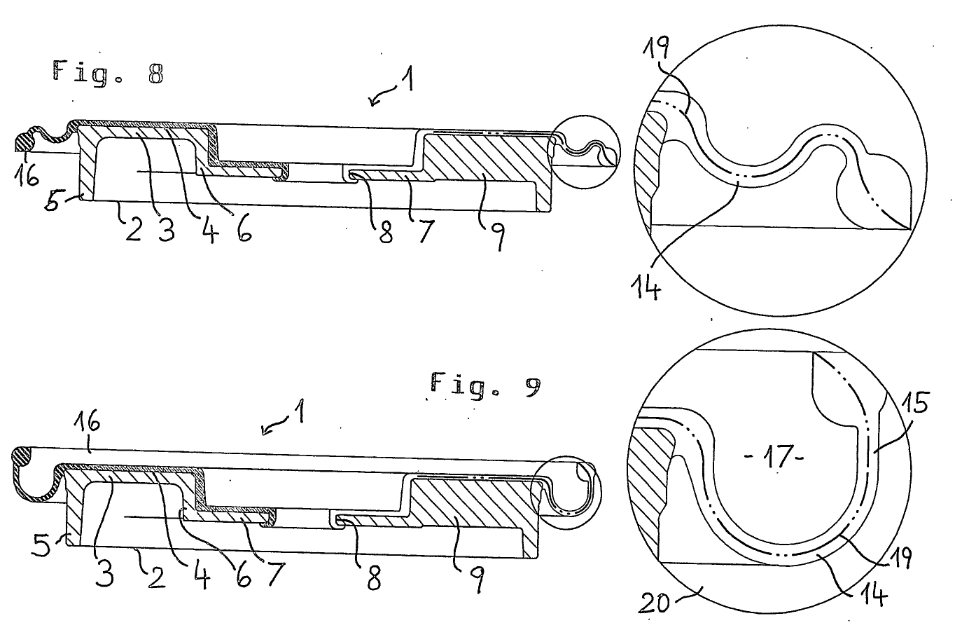

FIGS. 8 and 9 ditto for a fourth membrane according to the invention;

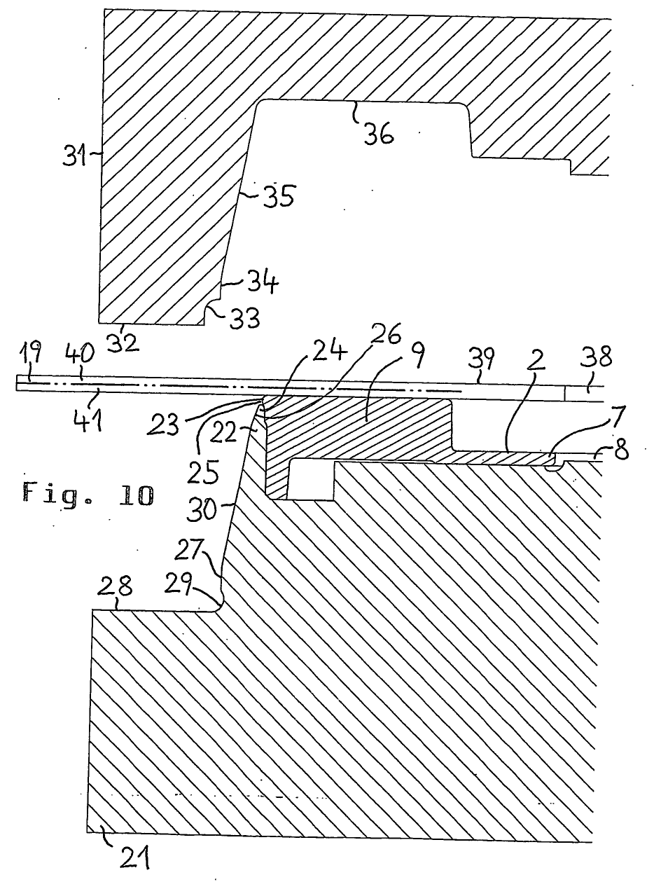

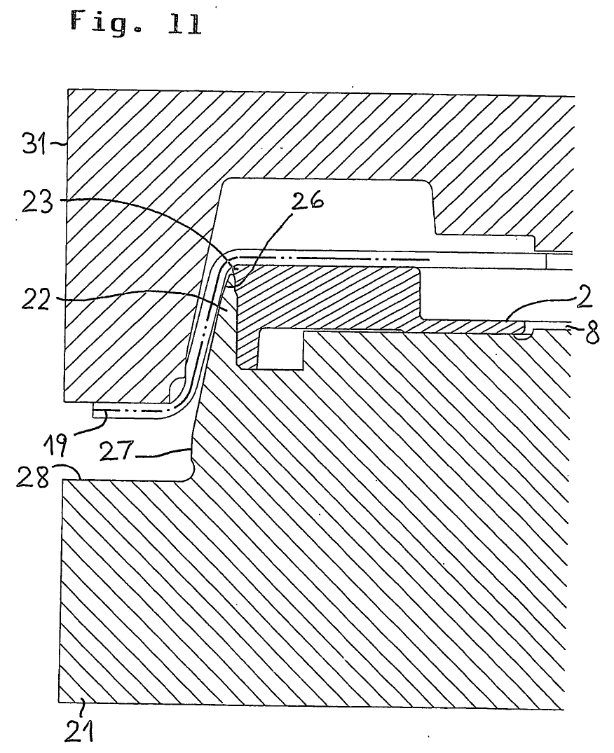

FIGS. 10-12 successive steps of the manufacturing according to the invention of a membrane according to FIGS. 4-9, when a form tool according to the invention is used.

A membrane 1 according to FIG. 1 preferably is manufactured jointly with and possibly is simultaneously cured on a support plate 2, e.g. made of a metal, in the shown membrane shape or form, which also is the application form. The support place has e.g. a ring portion 3 with an upper bearing surface 4, which has a radial extension, and with a connected, outer, somewhat longer axial flange 5 all around as well as a also connected inner, somewhat shorter axial wall 6 all around, the edge of which, which faces the bearing surface, being connected to a bottom 7, disposed in a radial plane and having a central circular hole 8. Between flange 5 and wall 6 spokes 9 may extend.

Membrane 1 is applied around hole 8 to come in contact with the lower side of bottom 7 against an edge area around hole 8. The membrane then follows the hole wall and the upper side of the bottom, wall 6 as well as bearing surface 4, which extends outwards in the form of a short projection 10 of the ring portion having an upper bend 11 and a lower, more accentuated or sharp step 12, which is a practical necessity in order to be able to connect a mold tool part to the support plate. The membrane follows the bend and axial outer side 13 of the projection and then continues in the form of a sweeping, from said step extending, in its cross section roughly circular arc-shaped curve 14 downwards and then upwards, and then continues in the form of an axial straight part 15 rearwards in relation to the initial phase of the described curve into a level above or axially in front of the bearing surface in order to in that location be terminated in the form of a bead 16, substantially circular in its cross section and which mainly can be disposed inside the area enclosed by said straight part and an imaginary continuation of same respectively.

The design now described is of course rotation symmetrical and the purpose is to let bead 16 be sealingly clamped up between e.g. two stationary valve parts (not shown), whereas hole 8 and the adjoining membrane portion will be applied on e.g. a valve spindle (not shown), and adjacent the bottom special bearing or fastening means (not shown) can be provided. The membrane for the rest is, jointly with an optional support plate, axially movably mounted, the movements mainly being designed to, during elastic deformation, be absorbed by curve 14 and the adjoining membrane portions. In the typical case, which is shown in FIG. 1, at least periodically there can be a higher pressure in a liquid or a gas on the upper or outer fastening side 17 of the membrane, where thus the concave portion of curve 14 mainly is exposed to the pressure drop. Side 17 is the pressure side, when the membrane is used or applied as well as when it is manufactured, in the latter case because a mold part, designed as an upper-die is used to create the curve and a certain tension in the plane starting layer of the membrane blank around the upper-die portions cannot be avoided.

It is shown in the enlarged portion of FIG. 1, that during the cure softened rubber layer 18 of the membrane is removed from the concave side of the curve and through reinforcement layer 19 of the membrane and to the concave side, the reinforcement material almost ending up on the surfaced within the inner side of the curve. This may result in, that pressurized liquids or gases, which influence the inner side of the curve, in an almost uncontrollable way will act through the reinforcement material and against the rubber layer on the other side of the reinforcement material, which rubber layer may expand to one or several bubbles, which of course result in severe functional disturbances and ultimately may break and completely suspend the function.

In order to solve these problems and reduce said risks there is provided according to the invention a method of forming or designing these membrane sections, which, when the membrane is applied, do not contact support surfaces and do not relocate or are deformed, when applied, respectively, at least partially with a manufacturing form or shape, which deviates from the shape of said sections, when they are applied.

The first embodiment according to the invention is shown in FIGS. 2 and 3, FIG. 3 outwardly substantially corresponding to FIG. 1. However, when studying the enlarged part of FIG. 3, it is obvious, that the reinforcement layer within the area with the curve 14 mainly is disposed close below the convex side. This means, that also maximally calculated pressure drops are not able to press the thick rubber layer on the pressure side of the membrane through the reinforcement layer into leeside 20 of the membrane. This has been done by manufacturing the membrane in the position shown in FIG. 2 with its curve with the convex side facing the pressure side. The manufacture is done in a way, which corresponds to that way, used for the design according to FIG. 1, a positional change for the lower-dies and the upper-dies however having been carried out and the straight part facing downwards rather than upwards. When a membrane has been cured in its position according to FIG. 2, curve 14 is turned downwards and straight part 15 upwards, the form to be applied, shown in FIG. 3, being obtained, which is retained, since this membrane form is self-stabilizing, which i.a. the more compact and consequently more elastic bead 16 contributes to.

However, due to the turning inside out of the membrane according to the invention it has a certain inherent elasticity, which tends to extend the curve radially outwards. This ought to in certain cases be taken into consideration and be compensated for, which is done by choosing a curve with a smaller bending radius in the manufacturing phase (see the enlargement part of FIG. 2). Then during the turning inside out into the application position an expansion independently takes place to the desired dimensions (see the enlargement part of FIG. 3).

Compared to the conventional form according to FIG. 1, which is not prestressed, the form according to FIG. 3 may result in a small displacement of the shoulder area of the curve from the outer side of the annular portion and the flange, since this shoulder area is bent almost 180° compared to the manufactured form. However, this probably is of no practical significance. in case some importance would be attached to it, a possible counter-measure would be to make the membrane somewhat thinner within the area with bend 11.

A projection 10 may be dispensed with completely, when selecting the design according to FIG. 2 and 3, since in the manufacture position according to FIG. 2 there is no requirement, that a form part be positioned below the curve.

Finally, it is to be noted, that the radial inside portion of the bead in the manufacture phase will be its radial outside portion in the application position. Consequently, a desired or existing bend and edge respectively is mounted during the manufacture on the opposite side in the radial direction in relation to the desired position during the mounting.

However, it is not necessary to manufacture an “upside-down” curve and then remake it to such a curve turned the right way. The designs according to FIGS. 4-7 show ways to, during the manufacture, extend the membrane section for the contemplated curve mainly with a straight divergence downwards, which can be described in a simple way, reference being made to FIGS. 10-12. Support plate 2 is there positioned in or on a lower mold tool half 21, which by means of the inner side of an upwardly projecting pointed ring 22 closely abuts the outer side of axial flange 5. The latter may adjacent ring portion 3 be somewhat extended in a step-like manner in a radial direction, whereas in the same plane as the ring portion a bend 23 projects further outwards in the radial direction and softly changes into bearing surface 44. Between bend 23 and joint 24 of ring 22 a small cut 25 is made, which during the cure will be filled with rubber material. The outer side of ring 22 diverges somewhat and mainly straight downwards but with a small bevel or bend 26 adjacent the point and a similar bevel or the like 27 adjacent the suitably radially outwardly extended stop face 28 of lower mold half 21, which stop face in its inner part has an annular void 29, against which bevel or the like 27 abuts and which is designed to form one side of bead 16. Thus, the two bevels or the like 26 and 27 are turned radially inwards with a small angle from the preferably straight intermediate portion 30 between them.

Upper mold tool half 31 is mainly form-complementary in relation to the lower one, abuts with a stop face 32 stop face 28, has a void 33, which is complementary in relation to the bead form and is, similar to the lower mold half provided with a bevel or the like 34 at a distance, equal to the membrane thickness, facing bevel or the like 27. However, an upper bevel or the like preferably is missing and instead straight portion 35, mounted on straight intermediate portion 30 of the mold tool half at a distance equal to the thickness of the membrane, continues all the way up to upper surface 36, located above bearing surface 4. The latter and straight portion 35 are connected to each other in the form of a soft bend and thus also provide space for a certain membrane enlargement 37 within the area with bevel or the like 26. For the rest the mold halves are designed in a conventional way to obtain the desired membrane shape.

According to FIG. 10 a support plate 2 has been disposed on the lower mold tool half and also an e.g. plane and cut membrane blank 39, provided with a central hole 38 and comprising two rubber layers 40 and 41, possibly connected to each other and preferably having a uniform thickness, and between the rubber layers a reinforcement layer 19, e.g. made of a somewhat thinner fabric

According to FIG. 11 the upper mold tool half has been lowered half-way onto the lower mold tool half, the deformation of the membrane blank being started.

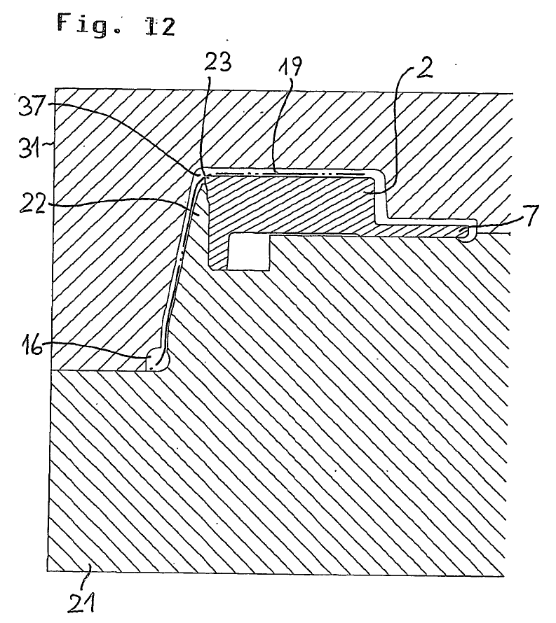

According to FIG. 12 the two mold tool halves have been completely brought together and in this position a curing and corresponding shaping of the membrane takes place. Thanks to the described and shown design already during the final phase of the transition from the position according to FIG. 11 to the position according to FIG. 12 a stretching of the membrane blank from the bearing surface to the bead takes place, since the mold tool halves between these two areas do not move straight towards each other, but the upper mold tool half slides past the lower one during their approach to each other. Finally, the two lower bevels or the like 27 and 34 and the adjoining void edges keep the membrane blank within this area between them in the shape of a nip, which pulls along and stretches the membrane somewhat against the action of lower rubber layer 41. However, this elasticity is suspended during the cure and becomes a softening, which allows the somewhat tight reinforcement layer to penetrate somewhat into the lower rubber layer, the softened material of which penetrates somewhat through the reinforcement material and is joined with upper rubber layer 49, which is shown in FIG. 12. In this position the rubber cures and the membrane becomes rigid, which thus has obtained an eccentrically disposed reinforcement layer. The two in the same direction gently angled bevels or the like 26 and 27 and straight intermediate portion 30 between the two bevels, which is relatively long in its axial direction, are responsible together with said nip and also the somewhat larger distance between the mold halves within the are of enlargement 37 for an adequate, i.e. gentle and uniform stretching force, applied to the reinforcement material, which in its turn can react in a corresponding way, i.e. with a uniform displacement into the lower rubber layer, a satisfactory and above all uniform working function for the membrane being secured.

The last-mentioned uniformity is illustrated by the obtained operating or mounting position according to FIG. 5, where the uniform extension of the reinforcement material throughout the entire curve is clearly visible. Only within the area of the curve shoulder is there a risk, that the reinforcement material will completely penetrate the lower rubber layer. However, enlargement 37 is able to protect and stabilize and prevent this from causing any functional disturbances or a premature material fatigue.

The embodiment according to FIGS. 6 and 7 corresponds to a high degree to the embodiment described above, but enlargement 37 surrounds bend 23 more completely than in the other embodiments and consequently constitutes a larger membrane support within the shoulder area of the curve. This embodiment is obtained by means of the form shown in FIGS. 10-12.

Finally, the embodiment according to FIGS. 8 and 9 shows a method of obtaining a centrally placed reinforcement material by giving only a portion of the curve, i.e. its outer part, located adjacent the bead, a shape with a more pronounced, differing manufacturing form in comparison to the application form. It is shown, that the part of the curve, located close to the bearing surface during the manufacturing in a weakened form corresponds to the desired application form, whereas the outer part is turned in the opposite direction compared to the application form. These two manufacturing curves, turned in mutually opposite directions are able to prevent, that one-sided tensile forces will influence the reinforcement material, which instead will remain centrically disposed, which is clearly indicated in FIG. 9.

The present invention is not limited to the embodiments described above and shown in the drawings but can be modified and supplemented in an arbitrary fashion within the scope of the inventive idea and the enclosed claims. Thus, any parts may be changed to any design and there replace and supplement the corresponding parts. Also, no support plate or other support elements are necessary. Thus, a membrane according to the invention can be manufactured individually or be manufactured together with arbitrary components. Beads and curves are not necessary. Also, in an arbitrary way designed, e.g. in their entirety more or less plane, membranes are included in the invention. In its simplest form a membrane according to the invention can comprise only one rubber layer and one reinforcement layer. Thanks to the fact, that the latter is fastened against the rubber layer during the cure, it is able to partially penetrate the rubber layer and bring about the characteristics of the invention.

1-12. (canceled)

13. A method of manufacturing a membrane (1) by curing one or several membrane blanks (39), which include at least one rubber layer (40, 41) and at least one permeable reinforcement layer (19), made of a fabric and placed adjacent the rubber layer and between two or several rubber layers,
wherein in order to counteract and prevent respectively undesirable displacements of the reinforcement layer (19) certain membrane sections (14), which in an application position do not contact support surfaces and are displaced or deformed, are manufactured with a form or shape, which deviates from the application form, and in that these membrane sections, by turning them inside out, are given desirable forms in the mounting and application positions, respectively.

14. The method according to claim 13, further comprising the step of exposing the reinforcement layer and layers (19) respectively to a stretching across the rubber layer extension during the cure in order to, within the membrane section (14), bring about a displacement of the reinforcement layer (19) across a portion of at least one of the rubber layers (40, 41) and consequently a position during the cure, which deviates from the building up of the blank.

15. The method according to claim 13, further comprising the step of manufacturing a membrane (1) having a ring section (14), which is convex in the mounting or application position, with this section having a concave form and with a rubber layer displaced (18) through the reinforcement layer (19) to the convex manufacturing side, the membrane subsequently being turned inside out to the convex form with the rubber layer displacement to the concave side.

16. The method according to claim 13, further comprising the step of manufacturing in a membrane having a ring section (14), which is concave towards the pressure side (17) in the application position, this ring section is manufactured on an upper-die part (21), designed mainly as a converging truncated cone, which is brought to cooperate with a substantially correspondingly designed lower-die part (31).

17. The method according to claim 16, further comprising the step of providing the envelope surface of the truncated cone, at one of the base and the top, with a bevel (26 and 27 respectively) in order to in the reinforcement layer (19) create a tension, directed towards the straight intermediate portion (30), positioned there between, as well as a partial penetration through an underlying rubber layer (41) during the cure.

18. The method according to claim 17, further comprising the step of designing the lower-die part (31) to follow the form within the area of at least one bevel (26 and 27 respectively) and/or to have an enlargement (37) and a thinning respectively.

19. The method according to claim 13, further comprising the step of manufacturing, in order to obtain a reinforcement position which is mainly unchanged in relation to the blank building up, a membrane ring portion, which is concave in the mounting or application position, partly in a concave and partly in a convex form, preferably with an inner part in a concave and with an outer part in a convex form, and that in the latter part in the mounting and the application position respectively is brought to occupy a concave form.

20. The membrane (1), manufactured according to the method according to claim 13, which membrane is made of one or several blanks (39) by curing them and which comprises at least one rubber layer (40, 41) and at least one permeable reinforcement layer (19), positioned adjacent the latter rubber layer and between several rubber layers respectively, and manufactured (19) of e.g. a fabric, wherein in order to counteract and prevent respectively undesirable displacements of the reinforcement layer (19) certain membrane sections (14), i.e. sections which in the application position do not come in contact with support surfaces and change location or are deformed respectively, are manufactured with a form, which deviates from the application form and shape, and are designed to, in the mounting and the application position respectively, be brought to, through a turning inside out, assume desirable forms or shapes.

21. The membrane according to claim 20, wherein the reinforcement layer and the reinforcement layers respectively (19) in the membrane section (14) are at least one of position-adjusted and tension-adjusted in relation to the blank building up through a displacement across a portion of at least one of the rubber layers (40, 41), since they during the cure have been exposed to stretching.

22. The member according to claim 20, wherein the membrane (1) has a ring section (14), which in the mounting or application position is concave in relation to the leeside (20), and is manufactured with this section having a concave form and with a rubber layer displacement (18) through the reinforcement layer (19) into the convex manufacturing side, and in that the manufactured ring section (14) having a concave form is turned inside out to a convex form with the rubber layer displaced to the concave side.

23. The membrane according to claim 20, wherein in order to obtain a reinforcement position, mainly unchanged in relation to the blank building up, a membrane ring part, which is concave in the mounting or the application position, is manufactured partly in a concave and partly in a convex form, preferably with an inner concave and an outer convex part, and in that the latter part, in the mounting and in the application position, is turned inside out in order to assume a concave form.

24. The mold or die tool, designed to carry out the method according to claim 13, wherein which mold tool has an upper-die (21) and a lower-die (31) and is designed to receive e.g. plane membrane blanks in the form of at least one rubber layer (40,41) and at least one reinforcement layer, and to soften the rubber layer through curing and form the membrane, in order to counteract and prevent respectively undesirable displacements of the reinforcement layer (19), certain mold tool sections, designed for certain membrane sections (14), i.e. sections, which in the mounting or application position of the membrane have no contact with support surfaces and change positions or are deformed respectively, are designed with a form, which deviates from the mounting or application form of the membrane and which is designed to obtain the membrane in its mounting and application position by turning it inside out.
